(19) United States
(12) Patent Application Publication
(10) Pub. No.: US 2023/0234337 A1
(43) Pub. Date: Jul. 27, 2023

(54) LAMINATED PACKAGING MATERIAL COMPRISING ALUMINUM WITH IMPROVED RECYCLABILITY

(71) Applicant: SOCIETE DES PRODUITS NESTLE S.A., Vevey (CH)

(72) Inventor: SERGEY POPOV, Fribourg (CH)

(21) Appl. No.: 18/001,765

(22) PCT Filed: Jun. 17, 2021
(86) PCT No.: PCT/EP2021/066356

§ 371 Date: Dec. 14, 2022

(30) Foreign Application Priority Data
Jun. 17, 2020 (EP) 20180432.5

(51) Int. Cl. B32B 15/085; B32B 15/088; B32B 7/12; B32B 27/32; B32B 27/30; B32B 27/34

(52) U.S. Cl. CPC B32B 15/085; B32B 15/088; B32B 7/12; B32B 27/32; B32B 27/306; B32B 27/34; B32B 2250/02; B32B 2255/06; B32B 2255/26; B32B 2307/306; B32B 2307/4023; B32B 2307/514; B32B 2307/581; B32B 2307/584; B32B 2439/70; B32B 2439/46; B32B 2307/31; B32B 2270/00; B32B 37/12

(57) ABSTRACT

The present invention relates generally to the field of laminated packaging. In particular, the present invention relates to laminated flexible packaging comprising aluminium and a plastic sealant layer only on one side of the aluminium. One embodiment of the present invention relates to a laminated flexible packaging made at least in part from a laminated flexible packaging material comprising an aluminium foil layer, a plastic sealant layer and a coating, wherein the aluminium foil layer is laminated to the plastic sealant layer on the side facing the packaged product, the other side of the aluminium foil layer is coated with the coating but not laminated to a layer of plastic or paper, and wherein the laminated flexible packaging is manufactured from the laminated flexible packaging material on a horizontal form fill and seal (HFFS) machine.

### FIELD OF THE INVENTION

The present invention relates generally to the field of laminated packaging. In particular, the present invention relates to laminated flexible packaging comprising aluminium and a plastic sealant layer only on one side of the aluminium. One embodiment of the present invention relates to a laminated flexible packaging made at least in part from a laminated flexible packaging material comprising an aluminium foil layer, a plastic sealant layer and a coating, wherein the aluminium foil layer is laminated to the plastic sealant layer on the side facing the packaged product, the other side of the aluminium foil layer is coated with the coating but not laminated to a layer of plastic or paper, and wherein the laminated flexible packaging is manufactured from the laminated flexible packaging material on a horizontal or vertical form fill and seal machine.

### BACKGROUND OF THE INVENTION

Laminated structures with aluminium foil have been widely used for packaging as aluminium foil provides a number of advantages including exceptional barrier performance, dead-fold properties, specific haptics and a certain look. In the segment of flexible packaging that is formed on horizontal forming, filling and sealing (HFFS) lines or vertical forming, filling and sealing lines (VFFS), the state of the art for Aluminium foil containing laminated flexible packaging material implies that the Aluminium foil layer is laminated not only on the side facing the product, but also is laminated on the other (outer) side to an additional layer comprising either paper or PET film, or matte-OPP film, or another plastic film (exemplary final laminated structures with Aluminium foil: PET/Alu/PE, PET/Alu/PET/PE, PET/Alu/PP, PET/Alu/OPA/PP, OPP/Alu/PE, paper/Alu/PE, paper/PE/Alu/PE, etc). One of important functions of the outer film in the state-of-the-art solutions is the possibility to apply the image by reverse-printing on the outer film instead of direct-printing on the surface of Aluminium foil. Other important functions of the outer film in the state-of-the-art solutions are protecting the aluminium foil from exposure to diverse types of mechanical abuse including scratch and puncture as well as modifying the surface friction and mechanical properties of the laminate in the way that secures high packing efficiency which is defined as possibility to produce tight (hermetic) flexible packages on HFFS or VFFS lines with high speed without creating holes and ruptures in the aluminium foil layer resulting from stretching of the film when it is pulled through the packaging line, or resulting from the impact on the seam area when the heated sealing jaws hit and squeeze the packaging material to create the seal, or because of scratches and ruptures the laminate may receive while it is pulled over static metal elements of the packaging line. The described state-of-the-art design of laminated flexible packaging with Aluminium foil sandwiched between two layers of plastic or a layer of plastic and a layer of paper, would as a rule result in the weight percent of Aluminium in the packaging material to be below 30%.

The state-of the art composition of flexible packaging is however inferior to packaging solutions with content of Aluminium by weight of at least 30% from the point of view of the management of the end-of-life of packaging. Optimal existing end-of-life management of aluminium containing flexible packaging comprises the collection of packaging waste, sorting it at a material recovery facility (MRF), and recycling.

The percentage of aluminium weight in the structure is known to have a direct impact on the yields of automatic sorting by Eddy-current sorting lines that MRFs are equipped with. Exact sorting rates are specific to an individual MRF, but it is known that a significant portion of state-of-the art aluminium foil containing flexible packaging is lost to recycling as their aluminium weight percentage does not guaranty efficient sorting with equipment used by MRF.

A higher content of aluminium on the other hand would result in higher repelling forces generated during sorting on Eddy current lines, therefore a higher weight percent of Aluminium will allow higher sorting yields with flexible packaging that will contain over 30% of Aluminium by weight. It is also known that efficiency of sorting with Eddy current increases when pieces of flexible packaging are not flat, but crushed or crumpled, therefore it is expected that materials with higher tendency for permanent deformation rather than elastic deformation will demonstrate better sorting efficiency.

The material which gets successfully sorted by Eddy-current lines on MRF is normally sent to recycling. Recycling of flexible packaging laminates with Aluminium foil includes a step of pyrolysis which separates Aluminium from plastic, the first staying in the solid phase and the latter moving to the gas phase during pyrolysis. It is known that losses of material and energy during pyrolysis depend on the weight ratio of aluminium to plastic. Namely, the losses decrease when the proportion of plastic is reduced in favour of the proportion of aluminium.

It is also known that the profitability of recycling by pyrolysis increases when the proportion of plastic is reduced in favour of the proportion of aluminium.

A possibility to produce and use aluminium foil laminates with maximum of 20% of organic content by weight of the overall weight of the laminate was suggested in 1994 in WO 94/27818. This publication highlighted the potential advantage of aluminium foil laminates with maximum of 20% of organic content by weight for the recycling process typical for aluminium cans, that does not include the step of pyrolysis before smelting operation. The present inventors however believe that:

1) since 1994, due to the recent development of pyrolysis that is used in recycling process of aluminium containing waste mixtures, as the step that separates the organic content and concentrates the aluminium fraction before aluminium enters the recycling operation of smelting, limiting the content of organic part to 20% by weight is not as essential as it used to be on the date of publication of WO 94/27818. Industrial scale pyrolysis is today common as a pre-treatment step for recycling aluminium containing waste mixtures, with a content of 30% of aluminium by weight, and

2) limiting the content of the organic part, including the plastic films, to 20% of the total weight of the laminate leads to corresponding limitations to mechanical characteristics of such laminates, for example to their puncture resistance. The properties of plastic films and their thickness are known to play a critical role for puncture performance of the final laminates. It is also known that reduction of the share of plastic part in laminates with aluminium foil increases risks of consumers cutting their hands when pressing against a sharp corner as well as when trying to tear-open such a package. The present inventors assume that the above mentioned limitations in mechanical performance and safety significantly limit areas of competitiveness of aluminium foil laminates with maximum of 20% of organic content by weight as potential flexible packaging solutions.

Finally, state of the art flexible packaging laminates comprising aluminium are not very well foldable due to the low aluminium content and due to the elastic properties of plastic. Packaging made from such laminates tend to unfold themselves after folding, resulting in the packaging being harder to empty completely and being difficult to reclose.

The novel flexible packaging materials that are presented by the present document address these needs. Hence, the laminated flexible packaging in accordance with the present invention are characterised by a reduced proportion of plastic and a higher proportion of Aluminium in comparison to state-of-the-art laminates with Aluminium foil layer.

Therefore, the end-of-life of the novel flexible packaging materials is advantageous due to:
increased yields of sorting by Eddy-current lines on MRF,
reduced losses in recycling by pyrolysis, and/or
enhanced profitability of pyrolysis, which may incentivise faster development of collection, sorting and recycling practices.

It is therefore desirable to provide the art with a laminated flexible packaging that is made from a laminated flexible packaging material comprising aluminium on a conventional packaging machine, in particular a HFFS or a VFFS machine and that has a better end-of-life management and that is easier and/or more efficient to recycle that packaging material of the prior art.

Any reference to prior art documents in this specification is not to be considered an admission that such prior art is widely known or forms part of the common general knowledge in the field.

The objective of the present invention is to improve the state of the art and, in particular, to provide the art with a laminated flexible packaging comprising aluminium that has a better end-of-life management and/or that is easier and/or more efficient to recycle, that contains a comparably low amount of plastics, that allows easy emptying and/or that is easier to reclose, or to at least provide a useful alternative.

### SUMMARY OF THE INVENTION

The inventors were surprised to see that the objective of the present invention could be achieved by the subject matter of the independent claim. The dependent claims further develop the idea of the present invention.

In particular, the inventors have found that surprisingly good results are obtained with a laminated flexible packaging made at least in part from a laminated flexible packaging material comprising:

(i) an aluminium foil layer, wherein the aluminium is present in an amount comprised between 30% and 80% of the total weight of said laminated flexible packaging material,

(ii) a plastic sealant layer comprising a polyolefin (PO), a polyamide (PA), ethylenevinylalcohol (EVOH), wherein said plastic layer is present in an amount comprised between 20% and 70% of the total weight of said laminated flexible packaging material, and

(iii) a coating,

wherein the aluminium foil layer is laminated to the plastic sealant layer on the side facing the packaged product, the other side of the aluminium foil layer is coated with the coating but not laminated to a layer of plastic or paper, and wherein the laminated flexible packaging is manufactured from the laminated flexible packaging material on a horizontal form fill and seal (HFFS) machine.

State-of-the-art plastic aluminium laminates consist of aluminium foil sandwiched between two layers of plastic films or between a layer of a plastic film and a layer of paper. During recycling, the plastic and paper in the laminate is exposed to pyrolysis, a process in which organic material, such as plastic, is heated and broken down in the absence of oxygen. The inventors were surprised to see that they could produce plastic aluminium laminates in which the aluminium foil is not sandwiched between two layer of plastic films or between a layer of a plastic film and a layer of paper, but is only laminated to a plastic film on one side and coated on the other side. This allows an even better recovery of the aluminium. Further, less plastic is needed, so that less organic material needs to be subjected to pyrolysis.

Accordingly, the present invention provides a laminated flexible packaging made at least in part from a laminated flexible packaging material comprising an aluminium foil layer, a plastic sealant layer and a coating, wherein the aluminium foil layer is laminated to a plastic sealant film layer only on the side facing the packaged product. The other side of the aluminium foil layer may be coated with the coating but may not be laminated to any plastic layer. For the purpose of the present invention, the term “coating” may comprise a print.

Waste fractions comprising from 30 to 80 weight percent of aluminium and from 20 to 70 weight percent of organic constituents are known to be readily accepted for recycling through pyrolysis as a step of the recycling process preceding smelting. It is important that recycled aluminium delivered through this recycling route represents a valuable secondary material demanded by the market. The possibility to valorise recycled aluminium makes this type of waste interesting to recycle. The present inventors assume that an aluminium content in primary flexible packaging comprised between 30 and 80 percent by weight, provides commercial incentive to recycling that will stimulate further development of recycling infrastructure and practices, including development of collection of this type of waste, both by centralized and entrepreneurial collection. The present inventors assume that due to the economic incentive that aluminium recycling through pyrolysis brings, primary flexible packaging comprising 30 to 80 percent of aluminium by weight, at least in certain territories, will appear less likely to leak into environment or be lost to recycling in another way, when compared with primary flexible packaging comprising no aluminium or comprising less than 30% of aluminium by weight.

The laminated flexible packaging may be manufactured from the laminated flexible packaging material on a horizontal form fill and seal (HFFS) or on a vertical form seal (VFFS) machine.

The laminated flexible packaging of the invention may be a pre-made pouch. The difference with other types of packages made by HFFS or VFFS techniques, is that forming and filling pre-made pouches is not necessarily done as one step, but in the case of premade pouches, they are formed on one machine, and then transported and filled on another machine.

As used in this specification, the words “comprises”, “comprising”, and similar words, are not to be interpreted in an exclusive or exhaustive sense. In other words, they are intended to mean “including, but not limited to”.

The present inventors have shown that it was possible to provide laminated flexible packaging made from laminated flexible packaging material comprising an aluminium foil layer, a plastic sealant layer and a coating on conventional packaging machines including vertical form fill and seal (VFFS) machines, horizontal form fill and seal (HFFS) machines as well as on a filling machine using pre-made pouches, wherein the aluminium foil layer is laminated to a plastic sealant film layer only on the side facing the packaged product. It was surprisingly demonstrated that the use of a coating on the external side of the aluminium foil can be sufficient to modify the properties of the packaging material of present invention in a way that allows the use of this material for forming flexible packaging on VFFS or HFFS lines without creating holes and ruptures in the aluminium foil resulting from stretching of the film when it is pulled through the packaging line, or resulting from the impact on the seam area when the heated sealing jaws hit and squeeze the packaging material to create the seal, or because of scratches and ruptures the laminate may receive while it is pulled over static metal elements of the packaging line. It is currently believed that the necessary level of protection of the surface of printed or unprinted aluminium foil allowing the use of the packaging material of present invention on VFFS or HFFS lines is facilitated by the ability of the coating to ensure a stable and sufficiently low coefficient of friction of the external surface of the laminate against metal. It is also currently believed that a necessary level of protection of the surface of printed or unprinted aluminium foil allowing the use of the packaging material of present invention on VFFS or HFFS lines is facilitated by the ability of the material of the coating to dissipate the energy and redistribute to wider area of aluminium foil surface the forces of certain types of mechanical abuse that are characterized by concentration of abuse force in small areas, such as those that are referred to as “scratching” and “puncturing”. It is further currently believed that the protective functions of the coating are facilitated by the ability of the coating to provide stable dynamic coefficient of friction of the external side of the packaging material of present invention below 0.55, and desirably below 0.45, and more desirably below 0.35. It is hypothesized that the protective functions of the coating are facilitated by the thickness of coating exceeding 0.25 micron, and desirably exceeding 1.5 micron, and more desirably exceeding 2.5 micron.

The resulting laminated flexible packaging had a higher aluminum content and a lower plastic content than state of the art materials, allowing a better recyclability, in particular of the aluminum. In addition, the resulting laminated flexible packaging was easier to re-close. The packaging was very burst resistant in a burst test reaching a burst resistance for pressures or 1.2 bar or more with a thickness of the aluminum foil of 20 μm. 1 bar is an SI derived unit corresponding to 100.000 N/m2.

In a practice test with food products it was found that it is possible to use a packaging in accordance with the present invention to package gravy and subject it to thermal sterilization process typical for wet pet food without any problems.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 shows the schematic composition of State-of-the-art exemplary structure (left) and the novel structure (right);

FIG. 2 shows a flexible pouch of Alu, 12 μm/MDO CPP, 60 μm formed on a HFFS line, no product inside;

FIG. 3 shows a flexible pouch of Alu, 20 μm/MDO CPP, 75 μm formed on HFFS filled with pet food gravy, after retorting;

FIG. 4 shows the back side of a pouch according to FIG. 3;

FIG. 5 shows the appearance of the samples after forming of the folds;

FIG. 6 shows the positioning of samples for measuring of angle recovery;

FIG. 7 shows a depiction of two consecutive folds of 10 mm width;

FIG. 8 shows a comparative weight gain curves of moisture sorption of reclosed pouches in SPSx-1 μ Vapor Sorption Analyzer from proUmid at 23° C. and 50% relative humidity;

FIG. 9 shows typical puncture curves;

FIG. 10 shows a comparison of COF curves;

FIG. 11 shows the visual appearance of the surface of the OPV coated packaging material PMSPO_12-75 after a COF test;

FIG. 12 shows the visual appearance of the surface of the packaging material Alu 12/SB ADH/mdo PP 75 without coating on the surface of aluminum foil after a COF test;

FIG. 13 shows a pouch formed with a material according to the invention, which contains a print damage in the barrier blade area at the heat-sealed sides, observed only on the samples of the first few cycles after machine start, and then no visible damage of the aluminium layer.

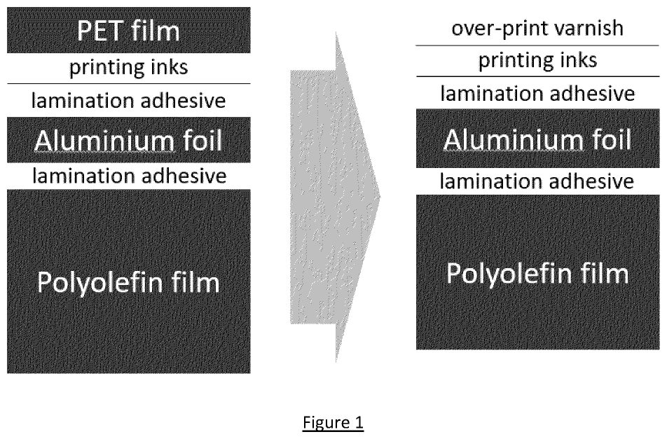

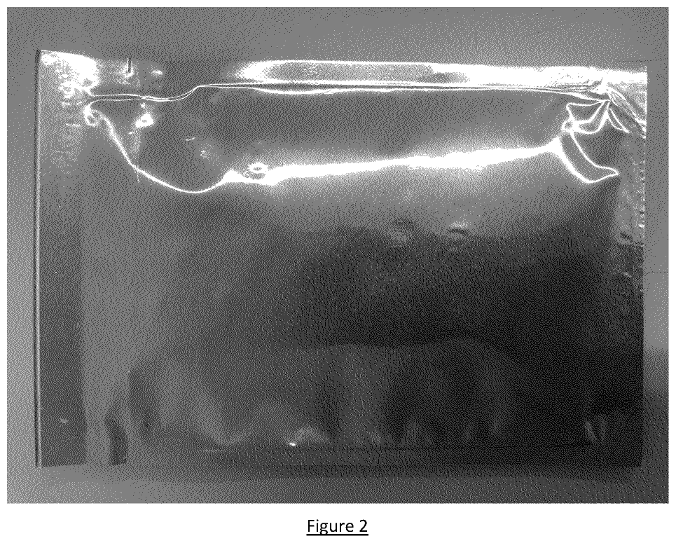

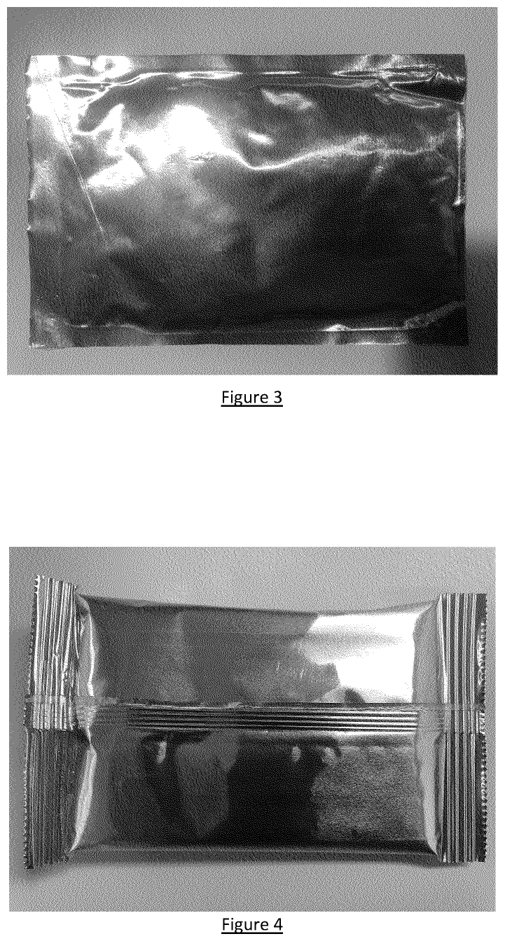

### DETAILED DESCRIPTION OF THE INVENTION

Consequently, the present invention relates in part to a laminated flexible packaging made at least in part from a laminated flexible packaging material comprising an aluminum foil layer, a plastic sealant layer and a coating, wherein the aluminum foil layer is laminated to the plastic sealant layer on the side facing the packaged product, the other side of the aluminum foil layer is coated with the coating but not laminated to a plastic layer, and wherein the laminated flexible packaging is manufactured from the laminated flexible packaging material, on conventional packaging machines including vertical form fill and seal (VFFS) machines, horizontal form fill and seal (HFFS) machines as well as on a filling machine using pre-made pouches.

HFFS machines are well known in the art. Together with vertical form fill and seal (VFFS) machines they represent the two most widely used form fill and seal machines in flexible packaging. The key difference between these two types of form fill and seal machines is how the products in these machines are dispensed into the packaging. HFFS machines are known to be very versatile. HFFS machines are widely used to form rigid packaging as well as flexible packaging. Typical examples of rigid packaging formed on HFFS lines include capsules, blisters, trays and cups with lids.

For the purpose of the present invention, a packaging and/or a packaging material shall be considered flexible, if it can be easily bent without breaking. For example, a flexible packaging and/or a flexible packaging material in accordance with the present invention may be bendable by hand.

The flexible packaging and/or the flexible packaging material in accordance with the present invention may be produced from many materials in addition to aluminum and plastic, including paper, films, or combinations thereof. Typical flexible packaging in accordance with the present invention may be selected from the group consisting of sachets, pouches, stand-up pouches, gusseted pouches, doy-packs, pillow-bags, flow-wraps, bags, labels, liners, sachets, wraps, and rollstock.

Using aluminum in laminated packaging has the advantage that it is general easily recyclable and imparts a performant oxygen, flavor and light barrier to the packaging.

As aluminum foil, any aluminum foil may be used for the purpose of the present invention. Typically, aluminum foil has a thickness of less than 0.2 mm. Regular household aluminum foil has a thickness of 0.024 mm. The inventors have found that for the laminated flexible packaging in accordance with the present invention particular beneficial results are obtained when the aluminum foil layer of the laminated flexible packaging material has a thickness in the range of about 8-30 μm, preferably in the range of about 10-22 μm. This allowed an optimum stability of the packaging ensuring safety, and at the same time provided an excellent moisture, light and odor barrier.

The flexible packaging and/or the flexible packaging material in accordance with the present invention may have an aluminum content of at least 30% of aluminum by weight, at least 40% of aluminum by weight, or at least 50% of aluminum by weight. As stated above, a high aluminum content will ensure a good aluminum recovery during automatic sorting by Eddy-current sorting lines that MRFs are equipped with.

The surface of the aluminum foil layer may be treated by application of a primer, silicatization or titanization. Primaring, silicatization or titanization of the surface of the aluminum foil layer can lead to an even better bond strength between the aluminum foil layer and the plastic sealant layer. Also, resistance of the packaging of the present invention to corrosion can be increased by primering, silicatization or titanization of the aluminum foil layer.

As plastic sealant layer, any plastic sealant layer may be used. A person skilled in the art will be able to select an appropriate plastic sealant layer. It may be advantageous, if the plastic sealant layer is formulated with a plastic that does contain as little heteroatoms in the backbone as possible. For example, the plastic sealant layer may be formulated with a plastic that does contain less than 10% heteroatoms in the backbone, less than 5% heteroatoms in the backbone, less than 2% heteroatoms in the backbone, or less than 0.1% heteroatoms in the backbone. This has the advantage that recyclability will be improved.

For example, the plastic sealant layer may be formulated with aliphatic polyolefins (PO)s, further for example aliphatic POs selected from the group consisting of polypropylene homopolymers; polypropylene copolymers including but not limited to the block-copolymers or random-copolymers of propylene with ethylene and other alpha-olefins; polyethylene homopolymers; polyethylene copolymers including but not limited to the copolymers of ethylene with alpha-olefins (LLDPE), cyclic olefins (COC), vinyl acetate (EVA), acrylic acid (EAA), methacrylic acid (EMA), esters of acrylic acid, esters of methacrylic acid, salts of acrylic or methacrylic acids (ionomers); maleic anhydride grafted variations of the plastics listed above; or combinations of the plastics listed above. The plastic sealant layer may be prepared, for example, by compounding, extrusion-blending, coextruding, extrusion-laminating, extrusion-coating, laminating with an adhesive or combinations thereof.

In the present invention, the plastic sealant layer, even though referred in the present document to as a single layer, can comprise multiple separate plastic films laminates together, for example by adhesive of extrusion lamination. The multiple plastic films joined by lamination to form the plastic sealant layer do not have to be produced of same type of material, instead they may combine materials of different types, including both sealable and non-sealable materials. For example, the plastic sealant layer may be built by laminating a polyamide film with a polyolefin film.

For the sake of meeting requirements of a specific application the laminate is designed for, any of the films in the plastic sealant layer may carry a functional coating or comprise coextruded layer of a functional material such as ethylene-vinyl alcohol (EVOH) or polyamide (PA).

In one preferred embodiment of the invention, the plastic sealing layer that is laminated to the aluminium layer, comprises one layer of oriented polypropylene (OPP) laminated to a layer of cast polypropylene (cPP). The association of three layers of: Aluminium, OPP, and cPP, was found to achieve surprisingly good results. The OPP and cPP layers are preferably laminated by adhesive lamination or by extrusion lamination. Such constructions were surprisingly found to deliver valuable combination of properties including puncture resistance, sealability by ultrasonic sealing without damaging the aluminium layer, and providing a lower rate of aluminium cracking under mechanical stress.

A person skilled in the art will be able to select an appropriate thickness for the plastic sealant layer. The plastic sealant layer must allow the effective sealing of the packaging, which is often carried out under heat and pressure. For example, the plastic sealant layer of the Laminated flexible packaging material may have a thickness in the range of about 30-100 μm, preferably in the range of about 45-80 μm. Thicker plastic sealant layers will result in plastic waste, while thinner sealant layers may lead to problems in the sealing process, loss of mechanical characteristics including puncture resistance or risk of consumers cutting hands while tear-opening the packages.

The fact that the plastic sealant layer is applied to the side of the aluminum foil layer facing the product to be packaged allows that by applying heat and pressure during a certain time the two sealant layers in contact with each other will fuse together and form a seal.

Also, the presence of the plastic sealant layer on the side of the aluminum foil layer facing the product to be packaged protects the product to be packaged and the aluminum foil from redox reactions that otherwise could be caused from the contact of the aluminum and the product.

For some applications, it may be advantageous if the plastic sealant layer comprised an oriented PO film. This has the advantage that it imparts improved mechanical properties to the laminate. Deformation mechanisms of polymers, such as viscous deformation cause by molecular slippage is minimized. The molecular alignment caused by uncoiling is maximized. Further, it allows a straight tear mode when the packaging is torn open.

Accordingly, in the laminated flexible packaging in accordance with the present invention, the plastic sealant layer may comprise an oriented polyolefin (PO) film. The oriented PO film may be selected, for example, from the group consisting of machine direction orientated (MDO) films, tenter-frame bi-axially oriented (BO) films, double-bubble blown films, triple-bubble blown films, or combinations thereof.

For some applications, it may be preferable if there is an adhesive layer between the aluminum foil layer and the plastic sealant layer. The adhesive layer ensures an optimal adhesion between aluminum foil layer and plastic sealant layer, while avoiding any gaps in adhesion. Such gaps in adhesion may lead, for example, to corrosion or other impairments of the resulting packaging, which might get worse, for example for retort pouches during aseptic processing. Hence, the present invention also relates to a laminated flexible packaging in accordance with the present invention, wherein between the aluminum foil layer and the plastic sealant layer of the laminated flexible packaging material there is an adhesive layer. The adhesive layer may be, for example, a solvent-based lamination adhesive layer. Further the adhesive layer, for example, the solvent-based lamination adhesive layer may have a thickness in the range of 1.5-10 μm, preferably in the range of about 2-5 μm.

The laminated flexible packaging in accordance with the present invention may be further coated with one or more coatings providing further functionalities, optical properties, haptic properties or other further properties to the laminated flexible packaging in accordance with the present invention.

For example, the laminated flexible packaging in accordance with the present invention may be further coated with one or more coatings on the outside of the packaging. For example, in the laminated flexible packaging in accordance with the present invention, the aluminum layer of the laminated flexible packaging material may be coated on the side facing away from the packaged product with a coating. Hence, the subject matter of the present invention extends to a laminated flexible packaging in accordance with the present invention, wherein the aluminum layer of the laminated flexible packaging material is coated on the side facing away from the packaged product with a coating comprising an over-print varnish (OPV), at least one layer of printing ink, a primer or a combination thereof. For example, this coating may be either a single over-print varnish (OPV) or a layer of ink or another type of coating that functionally serves as an OPV or a combination of printing inks and an OPV on top of the inks. Any of the above mentioned coatings may be used without a primer or in combination with a primer on top of the primer. The coatings may be applied by a variety of techniques known to people skilled in the art, including application by printing with an engraved cylinder.

Without wishing to be bound by theory, the inventors currently believe that the protective functions of the coating are facilitated by the ability of the coating to provide a stable dynamic coefficient of friction of the external side of the packaging material of present invention of below 0.55, and desirably of below 0.45, and more desirably of below 0.35. It is hypothesized that the protective functions of the coating are facilitated by the thickness of coating. Hence, the thickness of the coating may be larger than about 0.25 micron, preferably larger than about 1.5 micron, and more preferably larger than about 2.5 micron.

If the coating contains a print, such a print may be a flexographic or a roto-gravure print. Often, inks are applied on top of a primer and covered by OPV.

A flexographic printing process uses a flexible relief plate for printing. This printing process is well suited for printing on aluminum foil, for example. It is often used in the food industry. Flexographic printing on non-porous substrates is preferred.

A roto-gravure printing may be considered a form of intaglio printing. What is to be printed is engraved onto an image carrier, usually a cylinder, which is then used in a rotary printing press.

Additionally or alternatively may the laminated flexible packaging in accordance with the present invention also be printed with other printing techniques, such as digital printing, ink-jet printing or laser printing, for example.

Preferably, digital printing, ink-jet printing or laser printing process may be carried out in-line with the packaging operation. In-line printing offers the advantage that one packaging material can be equipped with marks providing actual information defined at the moment of packing, like “best-before” date, as well as individual decorations for separate packs.

The laminated flexible packaging in accordance with the present invention may further be embossed. Embossing is a finishing technique for packaging that can be used to create visual and tactile effects that can be used to support brand messaging. Further, embossing allows it to code information for consumers with vision disabilities or for other additional functionalities.

The inventors have also found that the laminated flexible packaging in accordance with the present invention has dead-fold properties that offer an improved functionality of reclosability. Without wishing to be bound by theory, the inventors currently believe that this effect is due to the relatively high aluminum/plastic weight ratio that the packaging in accordance with the present invention has. While a high plastic content has the consequence that a folded packaging will unfold itself, a low plastic content will have the consequence that a folded packaging of the present invention will stay folded. This allows a reclosing of the packaging of the present invention, which will improve safety and will help to avoid the generation of food waste. Consequently, additional elements to introduce the possibility of reclosing can be used in the packaging of the present invention, but are not necessarily required. Such additional elements are well known to the person skilled in the art and include sealed-in spouts, sealed-in valves, sealed-in zip-locks, sealed-in easy-locks, clips, staples, stickers, pressure-sensitive adhesive (PSA) coatings, for example.

The laminated flexible packaging material that is used in the framework of the present invention can be manufactured by methods that are well known to the person skilled in the art. For example, the laminated flexible packaging material can be manufactured by laminating aluminum foil to a plastic sealant film in-line with application of coatings, such as primers inks and/or OPV.

The fact that the laminated flexible packaging in accordance with the present invention allows it to have only one instead of two plastic layers results in a relatively high aluminum content of the packaging in accordance with the present invention and/or a relatively low plastic content of the packaging in accordance with the present invention. For example, the laminated flexible packaging in accordance with the present invention may contain at least 30% of aluminum by weight, at least 40% of aluminum by weight, or at least 50% of aluminum by weight. Further, for example the laminated flexible packaging in accordance with the present invention may contain less than about 70% of plastics by weight, less than about 60% of plastics by weight, or less than about 50% of plastics by weight. Consequently, the laminated flexible packaging in accordance with the present invention may have a weight ratio of aluminum/plastic of more than 0.4, of more than 0.6, or of more than 0.8.

The inventors have found that the laminated flexible packaging in accordance with the present invention has functional characteristics that make it suitable to package products, for example food products. For the purpose of the present invention the term “food” shall mean in accordance with Codex Alimentarius any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

The inventors have further found that the laminated flexible packaging in accordance with the present invention has functional characteristics that make it suitable to package pet food products.

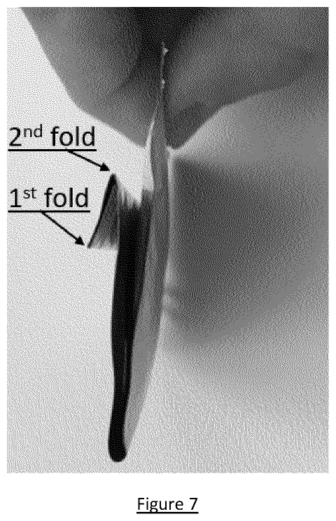

For example, in the laminated flexible packaging in accordance with the present invention, the laminated flexible packaging may have a puncture resistance of at least 7N of puncture force, 2.1mm of puncture elongation, and 8 mJ of puncture work (FIG. 6 and FIG. 7). Puncture resistance was measured from outside to inside at the speed of 100 mm/min, other parameters of the test being in accordance with DIN14477, herein incorporated in its entirety by reference. As the inventors surprisingly found, puncture resistance was further increased to 14N of puncture force and 10 mJ of puncture work, by using a sealable plastic layer comprising a 20 μm thick BOPP (bi-oriented polypropylene) film adhesive, laminated to 33 μm thick cPP (cast polypropylene) film.

Further, the laminated flexible packaging in accordance with the present invention may have a resistance to thermal sterilization during retorting of at least 121° C., of at least 128° C., or of at least 134° C.

The barrier performance of the resulting laminates, such as oxygen transmission rate (OTR), water vapor transmission rate (WVTR) and barrier to light are largely defined by intrinsic barrier properties of the aluminum foil which is used in the laminated flexible packaging material in accordance with the present invention. Additionally or alternatively, the laminated flexible packaging in accordance with the present invention may withstand at least 1.0 bar, 1.2 bar, or 1.3 bar in a burst test. The burst test may be carried out with a burst tester from Thimonnier at air injection speed of 6 l/minute

Those skilled in the art will understand that they can freely combine all features of the present invention disclosed herein. In particular, features described for the product of the present invention may be combined with the use of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

### Materials

1. Raw materials for production of samples of packaging:
Aluminium foil (Alu) of 12 μm thickness (Alu 12), in reels, commercial packaging grade of 8021 alloy with Elongation A50 mm over 5% (in accordance with EN 10002 and EN 546),
Aluminium foil of 20 μm thickness (Alu 20), in reels, commercial packaging grade of 8021 alloy with Elongation A50 mm over 5% (in accordance with EN 10002 and EN 546),
Machine direction oriented cast polypropylene film (mdo PP) of 60 μm thickness (mdo PP 60), in reels, commercial packaging grade, resistant to thermal (retort) sterilization,
Machine direction oriented cast polypropylene film of 75 μm thickness (mdo PP 75), in reels, commercial packaging grade, resistant to thermal (retort) sterilization,
Bi-axially oriented polypropylene film (OPP) treated with plasma or corona from both sides, 20 μm thick. Exemplary grade: Jindal Bicor™ NNH 20.0
Cast Polypropylene film (CPP), retortable grade, 33 μm thick
Two-component solvent based lamination adhesive suitable for wet pet food packaging, thermally sterilized after packing (SB ADH),
Two-component solvent based over-print varnish providing the static COF of coated Alu against metal below 0.43 (OPV)
Developmental printable solutions: a printing primer and inks
2. The samples of packaging material:
The samples of packaging material are listed in the following Table 1.

TABLE 1
Samples of packaging material

| | | Novelty |
|---|---|---|
| Sample name | Sample structure | and purpose |
| PMSP0_12-60 | OPV/Alu 12/SB ADH/mdo PP 60 | Novel |
| PMSP0_12-75 | OPV/Alu 12/SB ADH/mdo PP 75 | Novel |
| PMSP0_20-60 | OPV/Alu 20/SB ADH/mdo PP 60 | Novel |
| PMSP0_20-75 | OPV/Alu 20/SB ADH/mdo PP 75 | Novel |
| Ref. PET 12/Alu | PET 12/Alu 7/CPP 60 | State-of-the-art, |
| 7/CPP 60 | | for reference |
| PMSP3_20-20-33 | OPV/printing inks/primer/Alu 20/ | Novel |
| | SB ADH/OPP 20/SB ADH/CPP 33 | |

### Methods

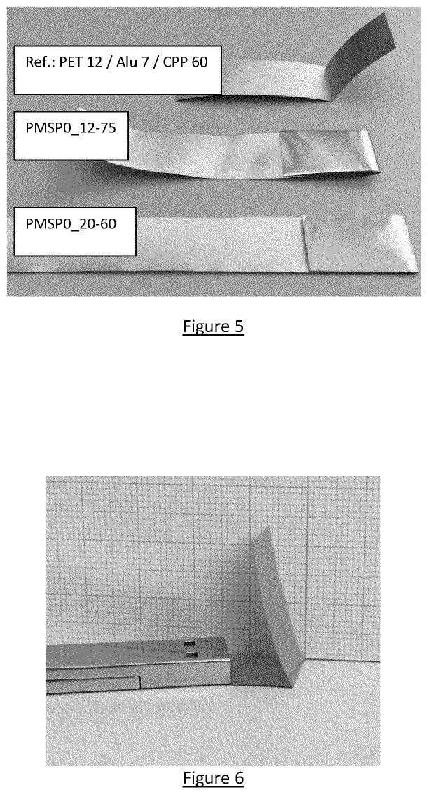

1. Preparation of the samples of packaging material:
   The four samples of packaging material described in the “Material” chapter above, were prepared in a two-step process. The first step was preparation of laminates of Alu and mdo PP by use of the SB ADH, applied at the dry coating weight of 3.5 g/m² by standard roto-gravure application technique on a combi-laminator Labo-Combi 400 from Nordmeccanica at the speed of 30 m/min. The second step was application of the protecting OPV on the surface of aluminium at dry coating weight of 3.3 g/m² by standard roto-gravure application technique on a combi-laminator Labo-Combi 400 from Nordmeccanica at the speed of 30 m/min. The laminates were cured between the two steps and after completion the second step, according to the instructions given in the technical description of the SB ADH. After curing the laminates were slit to the width of 280 mm to prepare them for use on a HFFS line for producing four-side-seal pouches of 140 mm height and 93 mm width.
2. Preparation of filled pouches on a HFFS line:
   The pouches, from materials PMSPO_12-60, PMSPO_12-75, PMSPO_20-60, PMSPO_20-75 and Ref. PET 12/Alu 7/CPP 60, were formed, filled with 30 g of pet food simulant (gravy sauce) and sealed by use of a HFFS packaging line Volpak SP 170. The filled pouches were subjected to thermal sterilization at 128° C., following a standard procedure.
   Settings on the HFFS line: the packaging line was operated at fixed speed of 50 cycles per minute. Only heat-sealing was used, without ultra-sonic assist. The thermal settings for the vertical, top and bottom sealing jaws were defined in an experiment that comprised of forming and sealing unfilled pouches followed by a check of hermeticity by a burst test. The burst test was performed by use of burst tester from Thimonnier at air injection speed of 6 l/minute.
3. Preparation of filled pouches in two steps:
   The pouches from material PMSP3_20-20-33 were formed on HFFS packaging line Volpak SP 170 by creation of bottom seal and vertical seals. After forming, the pouches were filled with 75 g of wet pet food and sealed on a Toyo Jidoki TT8DR filling line. Sealing after filling on the Toyo Jidoki TT8DR line was made by ultrasonic sealing followed by heat sealing of the pouch top. The filled pouches were subjected to thermal sterilization at 128° C., following a standard procedure.
4. Preparation of pouches on VFFS line:
   The pouches from materials PMSPO_12-60 and PMSPO_12-75 were formed on Wolf VPC 180 VFFS line. Sealing integrity was controlled with the leak tester Inficon Contura S400. The sealing integrity was assessed by testing of 10 pouches and was accepted in case all tested pouches proved the leak rate of below 0.01 mbar/l/s.
   Settings on the VFFS providing integral sealing: for sample PMSPO_12-60: Cycle time 0.6s, Vertical sealing temperature: 210° C., horizontal sealing temperature: 200° C.; for sample PMSPO_12-75: Cycle time 0.5 sec., vertical sealing temperature: 220° C., horizontal sealing temperature: 250° C.
5. Re-opening after folding:
   An internal method has been developed to analyze the ability of the material to be re-open after folding.
   The samples were cut to rectangular shapes of 15 mm width and a minimum of 70 mm length and were stored at room temperatures (20-25° C.). A fold in cross direction at 25 mm distance from the edge of laminate stripe was fixed by placing a metal cylinder of 2.611 kg weight and bottom surface of 3.75 cm², over it. FIG. 5 demonstrates appearance of the samples after forming of the folds. The weight was removed in 30 seconds: an angle of recovery was calculated by using a millimeter paper and the relation Angle=A sin (distance between the table and the top of the edge after angle recovery/distance between the crease and the edge, i.e. 25 mm). FIG. 6 demonstrates positioning of samples for measuring of the angle recovery. The distance and angle measurement have been done 30 seconds after removal of the mass and at least triplicates.
6. Reclosability efficiency:
   An internal method has been developed to analyse the reclosability efficiency of the pouches made with the different type of material.
   The pouches of 93 mm width and 140 mm height were stored at room temperature (20-25° C.) at least 24 hours before characterization. All the pouches were produced on a HFFS line as described above in “Methods” (2. Preparation of pouches on a HFFS line), but without filling. The pouches have been opened and filled with 2 g of desiccant. A fold was created at 10 mm from the edge of the pouch on the opened side by putting a metal cylinder on its side and rolling it over the pouch. The metal cylinder was of 2.611 kg weight, of 75 mm diameter and 75.5 mm height. A second fold on top of the first fold was created by rolling over the same metal cylinder second time in same way. FIG. 7 depicts the respective position of the two consecutive folds of 10 mm width. The way the second fold was created over the first one is illustrated on the picture FIG. 7. The filled pouches were analysed in accordance with the standard EN ISO 7783-1 by use of a Vapor Sorption Analyzer model SPSx-1 μ from proUmid for more than 60 hours at 23° C. and 50% relative humidity.
7. Puncture resistance:
   The puncture resistance has been measured following the ISO standard EN 14477 with a probe speed of 100 mm per minute and from outside to inside (i.e. from aluminum layer to CPP layer).
   The laminates were stored in a conditioned room (23° C. & 50% RH) at least 24 hours before the characterization and for each sample 10 measurements where performed and average is presented in the results
8. Surface friction properties:
   Coefficient of friction (COF) was measured in accordance with the method ASTM D1894. In addition, visual inspection of the external surface was made to detect development of defects on the surface after the friction test
9. Ultrasonic sealing:
   The quality of ultrasonic sealing was assessed by visual inspection of the seam area and measuring the seam strength with Zwick tensile tester.

### Results and Discussion

1. Hermeticity of sealing and burst test results
   Hermeticity was concluded when a series of 10 burst measurements did not include outliers or pouches demonstrating a leak during measurement or gradual mode of opening instead of burst (instant) mode of opening.
   Hermetic sealing was achieved with all samples, average of 10 burst measurements and standard deviation are summarized in the following Table 2.

TABLE 2
Burst test results

| | Results of burst | Results of burst |
|---|---|---|
| | measurement for pouch | measurement for pouch |
| | top, average of 10 | bottom, average of 10 |
| | samples +/− standard | samples +/− standard |
| Sample name | deviation, barr | deviation, barr |
| PMSP0_12-60 | 1.03 +/− 0.06 | 1.07 +/− 0.04 |
| PMSP0_12-75 | 1.15 +/− 0.06 | 1.25 +/− 0.07 |
| PMSP0_20-60 | 1.21 +/− 0.11 | 1.27 +/− 0.03 |
| PMSP0_20-75 | 1.28 +/− 0.09 | 1.37 +/− 0.06 |

2. Thermal (retort) sterilization:
   With packaging material samples: PMSPO_12-75, and PMSPO_20-75, one hundred pouches filled with 30 g gravy were subjected to thermal (retort) sterilization without injection of steam in an industrial sterilizer set to gradual heating to 128° C. in the course of 15 min, followed by 16 minutes at stable temperature of 128° C. followed by gradual cooling to 50° C. in the course of 15 minutes. The pouches were checked for leakages after cooling and in 5 days after retorting. It was found that no pouches had leakages. It was concluded that the pouches can successfully withstand thermal (retort) sterilization
3. Re-opening after folding:
   The angle recovery measured are summarized in the following Table 3.

TABLE 3
Angle recovery results

| | Angle in degree |
|---|---|
| Ref. PET 12/Alu 7/CPP 60 | 74.1 |
| PMSP0_12-75 | 21.5 |
| PMSP0_20-60 | 17.5 |

It is believed the test made it obvious that lower re-opening angles can be achieved by replacing the reference state-of-the art structure with the materials of invention like PMSPO_ 12-75, and preferably of PMSPO_20-60. It is hypothesised that this property is valuable for:
keeping freshness of food residues in pouches that were once opened, half-emptied and reclosed by folding the upper part of the pouch for longer time
during the end-of-life of packaging, whenever automated sorting by Eddy-current will be used, as deformed pouches will tend to be sorted easier than flat pouches due to modified aerodynamic properties.
4. Reclosability efficiency:
   The results of reclosability efficiency are expressed in the following Table 4 in g/pouch/day, respective weight gain curves are given in the FIG. 8.

TABLE 4
Results of reclosability efficiency in g/pouch/day

| | Sample 1 | Sample 2 | Sample 3 | Average |
|---|---|---|---|---|
| Ref. PET 12/Alu 7/CPP 60 | 6.6 | 2.6 | 4.4 | 4.5 |
| PMSP0_12-75 | 2.1 | | | |
| PMSP0_20-60 | 1.1 | | | |

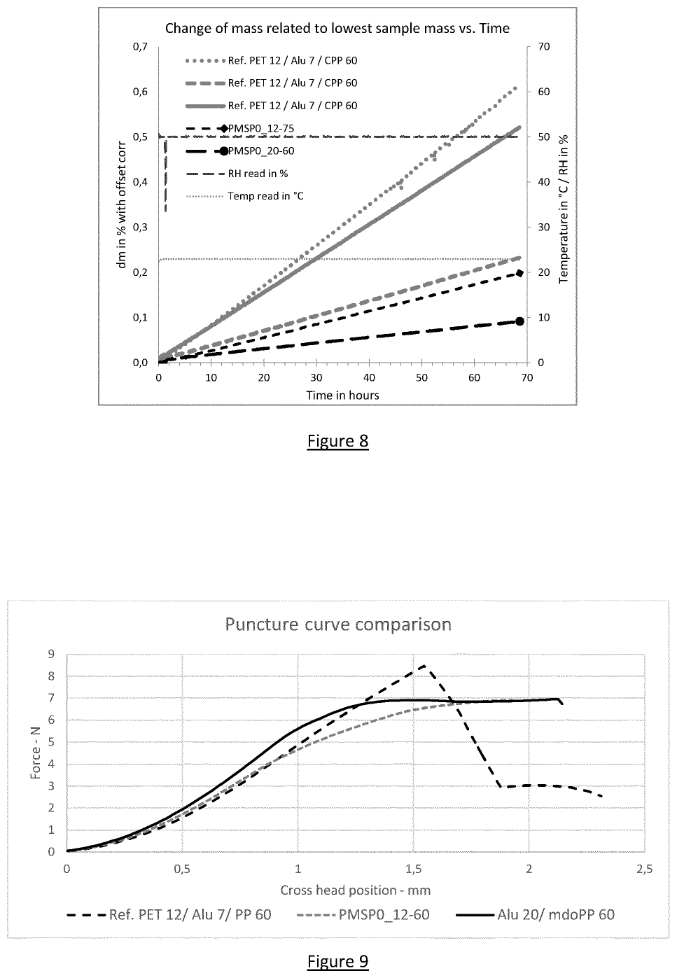

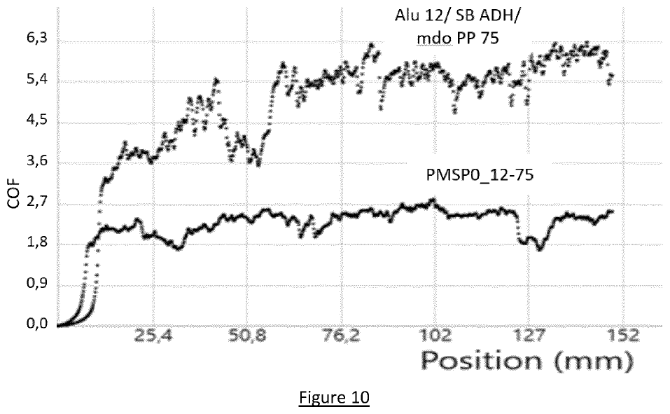

It is obvious that the new structure has much lower moisture uptake than the reference structure which could help for keeping freshness of food residues in pouches that were once opened, half-emptied and reclosed by folding the upper part of the pouch for longer time
5. Puncture resistance:
   The results of puncture resistance are given in the Table 5, comparison of typical puncture curves is given in FIG. 9.

TABLE 5
Results of puncture resistance

| | Peak force | Travel to peak | Energy to peak |
|---|---|---|---|
| Sample name | in N | force in mm | force in mJ |
| Ref. PET 12/ | 8.4 +/− 0.4 | 1.54 +/− 0.05 | 5.5 +/− 0.4 |
| Alu 7/CPP 60 | | | |
| PMSP0_12-60 | 6.9 +/− 0.3 | 2.1 +/− 0.1 | 8.4 +/− 0.6 |
| PMSP0_20-60 | 7.0 +/− 0.3 | 1.9 +/− 0.2 | 8.2 +/− 1.5 |
| PMSP3_20-20-33 | 14.0 +/− 0.2 | | 10.0 +/− 0.3 |

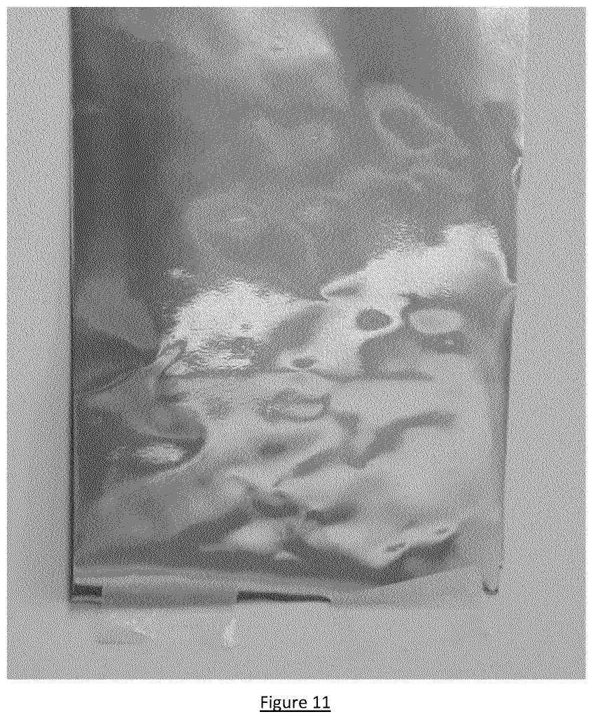

The experiment showed that the material of invention in the puncture test can demonstrate decreased “Peak force” and improved “Elongation to peak force” and “Energy to peak force”. It has to be studied how the change in puncture behavior will be transformed in robustness during the life-cycle of packaging
6. Surface friction properties:
   The results of the measurement of COF are given in the Table 6, comparison of typical COF curves is demonstrated on the FIG. 10, the visual appearance of the surface of the OPV coated packaging material after COF test is demonstrated on the FIG. 11, and the visual appearance of the surface of the packaging material without coating on the surface of aluminium foil after COF test is demonstrated on the FIG. 12.

TABLE 6
Results of COF measurements

| | | | Visual observation |
|---|---|---|---|
| | | | of defects on the |
| | | COF, external | surface, having |
| | | side to metal, | developed after |
| Sample name | Structure | dynamic | the COF test |
| PMSP0_12-75 | OPV/Alu 12/SB | 0.234 | No visible defects |
| | ADH/mdo PP 75 | | after COF |
| | | | measurement |
| Alu 12/SB | Alu 12/SB ADH/ | 0.518 | 3 lines after COF |
| ADH/mdo | mdo PP 75 | | measurement |
| PP 75 | | | |

The lower number of the COF and relatively smooth shape of the COF curve of the OPV coated packaging material PMSPO_12-75 compared to its analogue without the coating, as well as absence of scratches on the surface of the coated material after the COF test, evidence the ability of the coating to protect the surface of aluminium foil from scratches. The inventors hypothesize that the demonstrated protection of aluminium foil surface from scratches contributes to the ability of the packaging material of the present invention to be formed into flexible packaging on HFFS lines.
7. Ultrasonic sealing:
   The quality of ultrasonic sealing on samples produced from material PMSP3_20-20-33 on the Toyo Jidoki TT8DR line was concluded to be good based on the results summarized in Table 7 below.

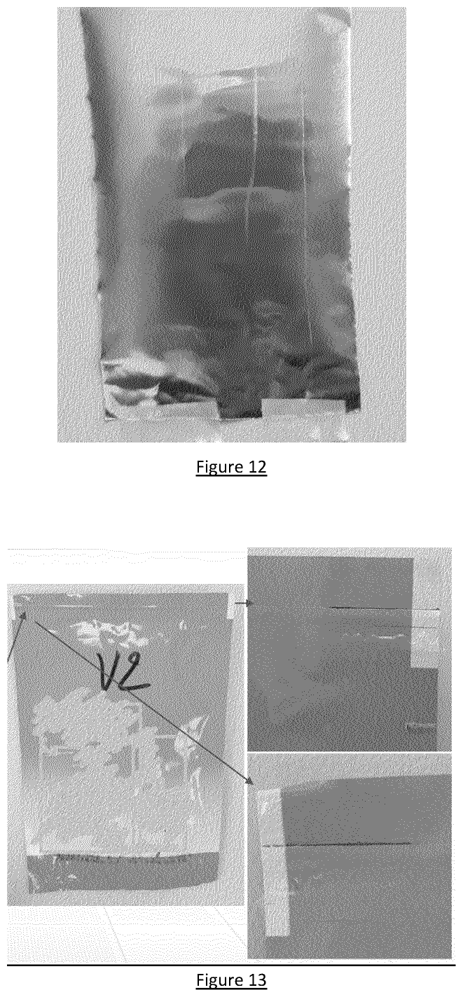

TABLE 7
Results of assessment of Ultrasonic sealing quality

| Sample name | Structure | Visual signs of damage | Seal strength |
|---|---|---|---|
| PMSP3_20-20-33 | OPV/printing inks/ | No visible damage of Alu layer, | 27-31N/15 mm |
| | primer/Alu 20/SB ADH/ | Print damage in the barrier | |
| | OPP 20/SB ADH/CPP 33 | blade area at the heat-sealed | |
| | | sides, observed only on the | |
| | | samples of the first few cycles | |
| | | after machine start (FIG. 13) | |

With the materials PMSPO_12-60, PMSPO_12-75, PMSPO_20-60, PMSPO_20-75 it was not possible to avoid visual damage to Aluminium layers and provide consistent sealing quality.

1. Laminated flexible packaging made at least in part from a laminated flexible packaging material comprising:
an aluminum foil layer, wherein the aluminum is present in an amount comprised between 30% and 80% of the total weight of said laminated flexible packaging material,
(ii) a plastic sealant layer comprising a polyolefin (PO), a polyamide (PA), and ethylenevinylalcohol (EVOH), wherein said plastic layer is present in an amount of between 20% and 70% of the total weight of said laminated flexible packaging material, and
(iii) a coating,
wherein the aluminum foil layer is laminated to the plastic sealant layer on the side facing the packaged product, the other side of the aluminum foil layer is coated with the coating but not laminated to a layer of plastic or paper, and wherein the laminated flexible packaging is manufactured from the laminated flexible packaging material on a horizontal form fill and seal (HFFS) or vertical form fill seal (VFFS) machine.

2. Laminated flexible packaging in accordance with claim 1, wherein the aluminum foil layer of the laminated flexible packaging material has a thickness in the range of about 8-30 μm.

3. Laminated flexible packaging in accordance with claim 1, wherein the surface of the aluminum foil layer-is treated on at least one side to increase bond strength.

4. Laminated flexible packaging in accordance with claim 1, wherein the plastic sealant layer of the laminated flexible packaging material has a thickness in the range of about 30-100 μm.

5. Laminated flexible packaging in accordance with claim 1, wherein the plastic sealant layer is selected from the group consisting of a monolayer cast film, a multilayer coextruded cast film, and a multilayer coextruded blown film.

6. Laminated flexible packaging in accordance with claim 1, wherein the plastic sealant layer comprises an oriented PO film.

7. Laminated flexible packaging according to claim 1, wherein the plastic sealant layer comprises a lamination of oriented polypropylene (OPP) layer with a cast polypropylene (cPP) layer.

8. Laminated flexible packaging in accordance with claim 1, wherein between the aluminum foil layer and the plastic sealant layer of the laminated flexible packaging material there is an adhesive layer.

9. Laminated flexible packaging in accordance with claim 1, wherein the aluminum layer of the laminated flexible packaging material is coated on the side facing away from the packaged product with a coating comprising an over-print varnish (OPV), at least one layer of printing ink, a primer or a combination thereof.

10. Laminated flexible packaging in accordance with claim 1, wherein the laminated flexible packaging contains at least 30% of aluminum by weight.

11. Laminated flexible packaging in accordance with claim 1, wherein the laminated flexible packaging contains less than about 70% of plastics by weight.

12. Laminated flexible packaging in accordance with claim 1, wherein the laminated flexible packaging has a puncture resistance of at least 7N of puncture force, 2.1mm of puncture elongation, and 8 mJ of puncture work

13. Laminated flexible packaging in accordance with claim 1, wherein the laminated flexible packaging has a resistance to thermal sterilization during retorting of at least 121° C.

14. Laminated flexible packaging in accordance with claim 1, wherein the laminated flexible packaging withstands at least 1.0 bar.
